(19) United States
(12) Patent Application Publication
(10) Pub. No.: US 2015/0191959 A1
(43) Pub. Date: Jul. 9, 2015

(54) SUN PROTECTION DEVICE

(71) Applicant: Fraunhofer-Gesellschaft zur Förderung der angewandten Forschung e.V., Munich (DE)

(72) Inventors: Andreas Schmohl, Munich (DE); Christoph Schwitalla, Sauerlach (DE); Klaus Breuer, Aschau (DE)

(21) Appl. No.: 14/416,221

(22) PCT Filed: Jul. 22, 2013
(86) PCT No.: PCT/EP2013/065427

§ 371 Date: Jan. 21, 2015

(30) Foreign Application Priority Data
Jul. 23, 2012 (DE) 102012212848.4

(51) Int. Cl. E05F 17/00; E06B 9/36

(52) U.S. Cl. CPC E05F 17/00; E06B 9/36; E05F 2017/005

(57) ABSTRACT

The invention relates to a sun protection device having sun protection elements, where each of the sun protection elements have a housing in which a flexible membrane is arranged, where each sun protection element is connected to a reservoir containing a hydraulic fluid by means of a hydraulic line, the reservoir including a solar absorber, where the membrane is adapted to extend from the housing if the pressure in the hydraulic line increases.

This application is a national stage entry of International Patent Application PCT/EP2013/065427, filed Jul. 22, 2013, entitled “SUN PROTECTION DEVICE,” the entire contents of which are incorporated by reference, which in turn claims priority to German patent application 102012212848.4, filed Jul. 23, 2012, entitled “SONNENSCHUTZVORRICHTUNG”, the entire contents of which are incorporated by reference.

### BACKGROUND OF THE INVENTION

The invention relates to a sun protection device comprising a plurality of movable sun protection elements which can be moved from an open position to a closed position.

It is known from experience to equip buildings with windows and/or glass facades. They allow the users of the building to view the environment, on the one hand, and also the entry of solar energy into the building, on the other hand. This can be beneficial in winter to save heating costs. However, in summer, when the external temperatures are higher and/or when the solar radiation is very high, the rooms behind the windows strongly heat up, and therefore additional energy is required for the purpose of air conditioning or cooling. This considerably deteriorates the energy balance of the building, and therefore it is often desirable to temporarily shadow at least one window opening.

Known sun protection elements consist of a planar structure which is made of a metallic or textile material and can be moved by a user mechanically or by means of an electric motor from an open position to a closed position. Electromotive sun protection devices can be provided with a control or feedback-control apparatus, and therefore they can be moved to the always optimum position in a way operated by the weather without interference from the user.

This known sun protection device has the drawback that it either cannot be operated in the absence of the residents and/or users of the building or constantly requires electric energy for the control and electromotive adjustment, which further deteriorates the energy balance of the building.

Therefore, the object of the invention is to create a simple and cost-effective sun protection device which can be controlled without external energy supply and without interference from the user.

### SUMMARY

In one aspect, the invention relates to a sun protection device, comprising a plurality of movable sun protection elements which can be moved from an open position to a closed position, wherein the sun protection elements can be moved by the action of heat, wherein the sun protection elements are composed of at least one first layer of material having a first coefficient of thermal expansion α₁ and a third layer of material having a third coefficient of thermal expansion α₃, wherein the two layers of material are connected to each other on at least two opposite boundary edges.

In another aspect, the invention relates to a sun protection device having a plurality of sun protection elements, said sun protection elements each having a housing in which a flexible membrane is arranged, wherein each sun protection element is connected to a reservoir containing a hydraulic fluid by means of a hydraulic line, said reservoir comprising a solar absorber, wherein the membrane is adapted to extend from the housing if the pressure in the hydraulic line increases.

In still another aspect, the invention relates to a sun protection device having a plurality of sun protection elements, said sun protection elements each having a material strip made of a solid material, wherein each sun protection element is connected to a reservoir containing a hydraulic fluid by means of a hydraulic line, said reservoir comprising a solar absorber, wherein each sun protection element can be rotated about its longitudinal axis to move it from an open position to a closed position if the pressure in the hydraulic line increases and wherein each sun protection element can be rotated about its longitudinal axis to move it from a closed position to an open position if the pressure in the hydraulic line decreases.

The invention proposes to equip a window opening with a sun protection device which contains autonomously adaptive sun protection elements. The window opening can be provided with a transparent or translucent glazing. The glazing can be fixed or be inserted in a wing of a window in such a way that the window can be opened temporarily or is immovably fixed to the building as a glass facade. The glazing can have several approximately parallel panes. The window can separate the interior and exterior of a building, of a vehicle, of a ship or of a plane.

Movable sun protection elements are arranged at least in front of the window opening either on the inner or outer surface or between two panes of the glazing. The sun protection elements can be moved from an open position to a closed position. This should be interpreted such that the closed sun protection elements cast a shadow in the interior of the room, and therefore solar radiation is reflected back into the outdoor area, is diffusely reflected or absorbed by the sun protection element. A plurality of protection elements can be arranged in such a way that they produce a single shadow in the interior in a closed position, i.e. the shadow does not form a patch or striped pattern of the individual sun protection elements. In the open position, the sun protection elements either cannot cast a shadow in the interior or the shadow produced by the individual sun protection elements is at least somewhat smaller, and therefore shadowing increases continuously with the solar radiation up to a maximum value.

According to the invention, the sun protection elements are made in an autonomously adaptive way. This means that the sun protection elements respond to moisture, temperature, light intensity and/or heat, and therefore the sun protection elements automatically move from a closed position to an open position when the solar radiation and thus the heat exposure of the room is high, and the sun protection elements move from the open position to a closed position when the solar radiation and thus the heat exposure of the room is low. Since the sun protection elements obtain the energy required for the movement from the surroundings, no electric connection of the sun protection device and no interference from the user, such as the handling of a crank, are necessary. The sun protection elements can move depending on the environmental influences in accordance with the needs of the residents and/or users of the rooms lying behind and without consuming any additional energy.

The sun protection elements can be arranged in front of the window opening in horizontal or vertical fashion or at another angle, i.e. diagonally. In some embodiments of the invention, the sun protection elements can be divided both horizontally and vertically. The sun protection elements can be arranged in a retaining device which in addition to the autonomously adaptive movement also enables an electromotive or mechanical movement of the sun protection device. As a result, the sun protection device can be moved from an open position to a closed position both autonomously and manually.

In some embodiments of the invention, the sun protection elements can be movable by a mechanical system and/or hydraulic system. In this case, the thermal expansion of a mechanical component and/or a hydraulic fluid can be used to move the sun protection elements from an open position to a closed position. The hydraulic fluid can be or contain an alcohol or oil, for example. Some embodiments of the invention use a hydraulic fluid which has a large density difference depending on the temperature. In some embodiments of the invention, the hydraulic fluid can act on a mechanical system via a piston, e.g. a connecting rod or a transmission, to thus move the sun protection elements from the open position to the closed position and vice versa. In order to enable the necessary actuation forces and/or the necessary actuation path, the mechanical system and/or hydraulic system can have a transmission, a swiveling lever or piston/cylinder pairings of different diameter.

In some embodiments of the invention, the hydraulic fluid in the hydraulic system can be heated by means of at least one solar absorber. The solar absorber can have a coating which selectively absorbs a predefinable part of the solar spectrum to thus allow for a rapid heating of the hydraulic fluid. In some embodiments of the invention, the solar absorber may be adapted to selectively absorb infrared radiation. In some embodiments of the invention, this can lead to a more rapid heating of the hydraulic fluid than the glazing of the window opening and/or the room behind the window opening, and therefore the sun protection device may shadow the room before it heats up. In other embodiments of the invention, the solar absorber may be adapted to selectively absorb visible radiation, thereby reducing or preventing a response of the sun protection device when the sky is cloudy so as to avoid undesired shadowing during a cloudy sky.

In order to provide the user with an additional possibility of opening or closing the sun protection elements himself, the hydraulic fluid can be heated via another heat source, e.g. an electric heating cartridge and/or a gas burner. In other embodiments of the invention, the user can open and close the sun protection elements via a mechanical system which acts on the sun protection elements parallel to the hydraulic system and/or the hydraulic elements can be arranged on a mechanically movable carrier.

In some embodiments of the invention, the sun protection element can contain a material strip made of a solid material, e.g. a metal, an alloy or a plastic material. The sun protection element can be rotated about its longitudinal axis to move it from an open position to a closed position. A sun protection element made of a plastic material can contain or consist of carbon fibers. In addition, such a sun protection element can contain a thermoplastic resin or a thermosetting resin or an elastomer, e.g. an epoxy resin or a polyester resin. In some embodiments of the invention, the sun protection element can contain or consist of a fluorinated polymer. Such a sun protection element can be operated with minor actuation forces and/or has a good weather resistance due to its low weight.

In some embodiments of the invention, at least one sun protection element can contain a membrane in a housing, said membrane being reversibly extendible from the housing by means of a mechanical system and/or a hydraulic system. The housing can be made of metal or a plastic material, for example, as already described above by means of the planar sun protection elements. For example, the housing can be approximately cylindrical, and therefore a roller in the interior can wind up the membrane. The membrane as such can be made of a flexible plastic material, e.g. a carbon fiber reinforced laminate. The membrane can contain or consist of a fluorinated polymer so as to increase the weather resistance of the membrane.

In some embodiments of the invention, the sun protection element can be composed of at least one first layer of material having a first coefficient of thermal expansion and one third layer of material having a third coefficient of thermal expansion, wherein both layers of material are connected to each other at least at two opposite boundary edges. On account of the different coefficient of thermal expansion, a mechanical stress occurs in the sun protection elements during heating, said stress bulging the sun protection elements. As a result, the area projected by the sun protection element can increase in an observation direction, and therefore the bulged position of the sun protection element is the closed position. The sun protection element can be heated by solar radiation on a collector surface. The collector surface is heated by the solar radiation less on cold days than on hot days, and therefore the outside temperature can be used as an additional variable. The sun protection element according to this embodiment of the invention has an operating principle similar to that of generally known bimetal elements. However, it is not compulsory to make the sun protection element from a metal or an alloy. It can also contain or consist of different plastic materials and/or ceramics. In some embodiments of the invention, the sun protection element can contain or consist of a composite material made of a metal, a ceramic, an alloy and/or a plastic material.

In some embodiments of the invention, a second layer of material having a second coefficient of thermal expansion can be arranged between the first layer of material and the third layer of material. The second layer of material can be used for the mechanical reinforcement of the sun protection elements such that they are reliably held in the desired position which effects an efficient shadowing of the room behind the window opening.

In some embodiments of the invention, the second layer of material can contain or consist of carbon fibers. Carbon fibers have the advantage of being largely opaque so as to enable efficient shadowing. Furthermore, carbon fibers are insensitive to U.V. radiation, and therefore the sun protection device can function in maintenance-fee and reliable fashion for many years.

In some embodiments of the invention, the second layer of material can contain or consist of carbon fibers which are arranged along the longitudinal extension of the sun protection elements. In this way, the second layer of material does not change the modulus of elasticity of the sun protection elements in a direction transversely to the longitudinal extension, and therefore the sun protection elements can still be bulged by the mechanical stresses forming on account of the different thermal expansion. At the same time, the sun protection element is sufficiently rigid along its longitudinal extension so as to be able to reliably bridge large widths or large window openings.

In some embodiments of the invention, the distance between the first and third layers of material can be approximately 1 μm to approximately 200 μm. In some embodiments of the invention, the distance between the first and third layers of material can be approximately 5 μm to about 50 μm. According to the invention, it has been realized that the deformation of the sun protection elements is the higher the lower the distance between the two layers. At the same time, the indicated range is chosen in such a way that the sun protection elements have sufficient mechanical stability.

In some embodiments of the invention, the first layer of material contains e.g. polytetrafluoroethylene and/or at least one partially fluorinated polymer and/or polyvinyl chloride and/or polypropylene and/or silicone rubber and/or silicone-filled acetal copolymers and/or epoxy resin. These materials have a comparatively large thermal expansion having a coefficient of thermal expansion between about 5×10⁻⁵ K⁻¹ and about 2×10⁻⁴ K⁻¹.

Correspondingly, in some embodiments of the invention, the third layer of material can contain or consist of silicon dioxide and/or glass fibers and/or an iron-nickel alloy and/or basalt fibers and/or aluminum titanate and/or clay and/or carbon fibers and/or a material having a negative coefficient of thermal expansion. A material having a negative coefficient of thermal expansion can be or contain ZrW₂O₈, e.g. as fibers or filling materials. In some embodiments of the invention, such a layer of material can have a coefficient of thermal expansion between about −5×10⁻⁶ K⁻¹ and about 1.5×10⁻⁵ K⁻¹. In some embodiments of the invention, the coefficient of thermal expansion can be between about 5×10⁻⁷ K⁻¹ and about 5×10⁻⁶ K⁻¹. These differences are sufficient to obtain a corresponding deformation of the sun protection element so as to achieve a closed or partially closed position of the sun protection device during heating.

In some embodiments of the invention, at least the side of the sun protection elements, which faces the outer side of the building, can be designed in a diffusely reflecting way. This feature has the effect of avoiding external dazzling. The fact that the sun protection elements have a bulged shape in the closed position also contributes thereto, and therefore reflected light rays are defocussed.

In some embodiments of the invention, at least the side of the sun protection elements, which faces the outer side, can be equipped with a photoelectric cell, at least on a partial area thereof. In the closed position, the sun protection device can thus produce electric energy which can be used for ventilating the building, for example.

In some embodiments of the invention, the sun protection elements can be in contact with a solar absorber via at least one boundary edge. This enables the controlled heating and cooling of the sun protection elements. The solar absorber can have a coating that absorbs in a spectrally selective fashion to achieve a settable heating behavior upon solar radiation.

In some embodiments of the invention, the sun protection device can also contain at least two transparent or translucent panes which are spaced apart, wherein at least the sun protection elements are arranged between the panes. This avoids the mechanical damage of the sun protection elements, e.g. by careless users or wind action.

The invention is explained in more detail below by means of figures without limiting the general inventive concept, wherein:

### BRIEF DESCRIPTION OF THE DRAWINGS

FIG. 1 shows the cross-section through a sun protection device according to a first embodiment.

FIG. 2 shows the cross-section through a sun protection device according to a second embodiment.

FIG. 3 shows an enlarged section of FIGS. 1 and 2.

FIG. 4 shows the functional principle of a sun protection element.

FIG. 5 shows a window opening equipped with the sun protection device according to FIG. 1 in an open position.

FIG. 6 shows the sun protection device according to FIG. 5 in a closed position.

FIG. 7 shows a first embodiment of the structure of a sun protection element.

FIG. 8 shows a section of FIG. 7.

FIG. 9 shows a second embodiment of the design of a sun protection element.

FIG. 10 shows the behavior of the sun protection device according to FIG. 1 at different temperatures.

FIG. 11 shows a third embodiment of the sun protection device in an open position.

FIG. 12 shows the sun protection device according to FIG. 11 in a closed position.

FIG. 13 shows a fourth embodiment of the sun protection device.

### DETAILED DESCRIPTION OF THE INVENTION

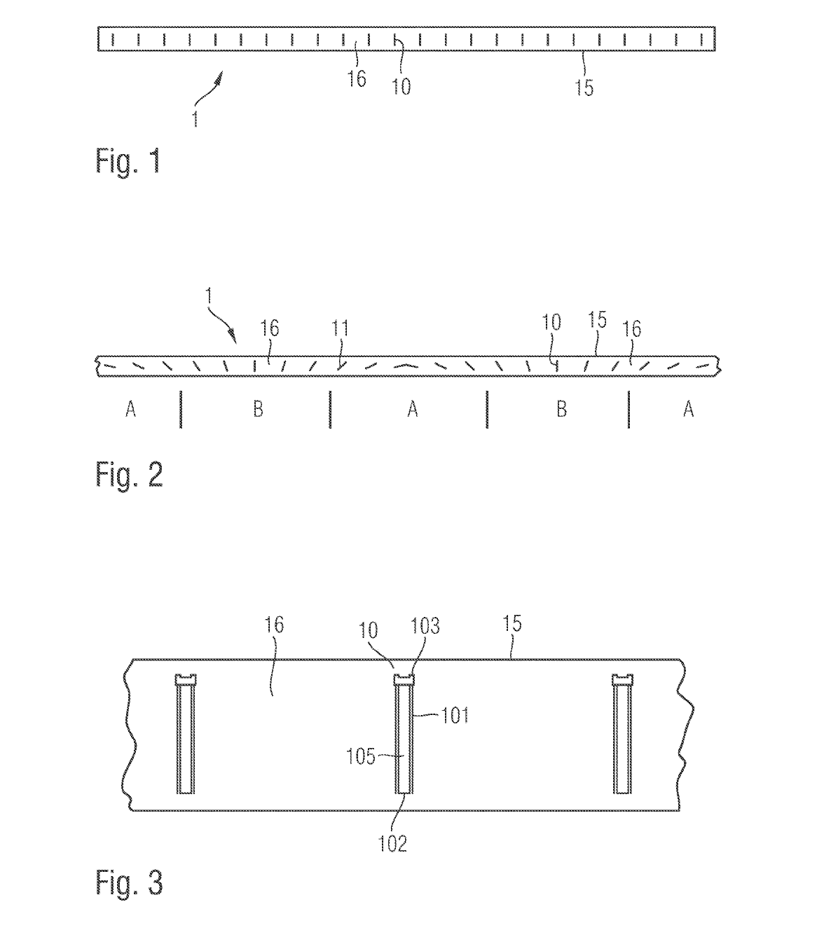

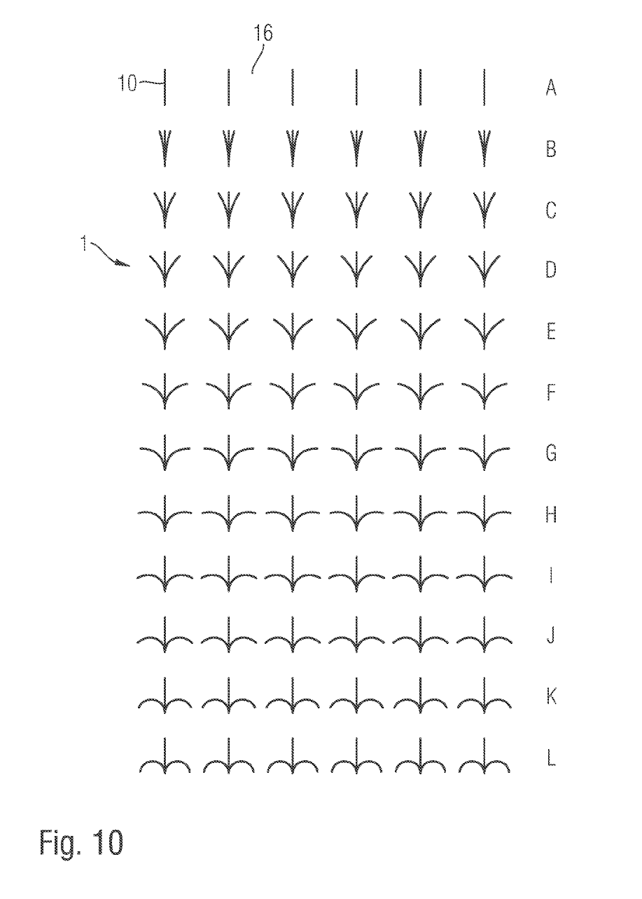

FIG. 1 shows a first embodiment of a sun protection device according to the invention. The sun protection device 1 comprises a plurality of sun protection elements 10 which are arranged between two transparent or translucent panes 15. This serves for avoiding mechanical damage to or the influence of precipitation on the sun protection elements 10. The sun protection elements include a front face having a comparatively small cross-section. In some embodiments of the invention, this cross-section can be between about 1 mm and about 10 mm. Furthermore, the sun protection elements have a width of about 10 mm in a direction orthogonal to the panes 15. In other embodiments of the invention, this width can vary from about 3 mm to about 50 mm. As a result, only the narrow front face of the sun protection elements 10 is visible in the open position thereof. The sun protection elements 10 only fill the intermediate space 16 in the closed position and increasingly shadow the room therebehind, as will be explained on the basis of FIG. 10. In the exemplary embodiment according to FIG. 1, the sun protection elements 10 are arranged approximately orthogonal to the plane of the panes 15 and are equidistant. In other exemplary embodiments of the invention, the sun protection elements 10 can also be inclined and/or have different distances to one another.

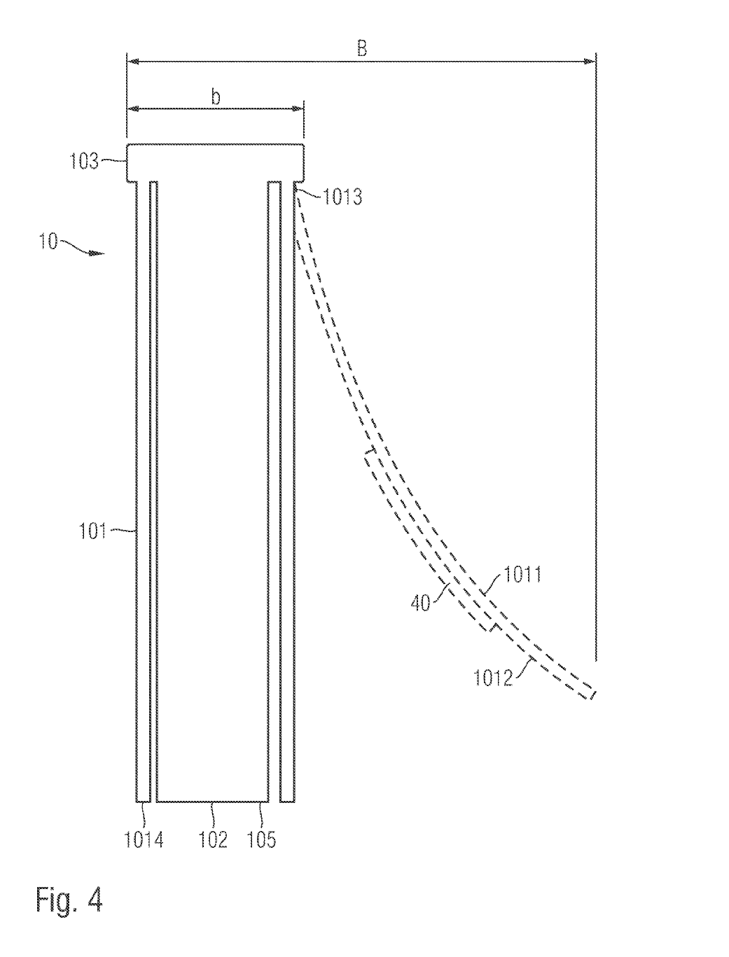

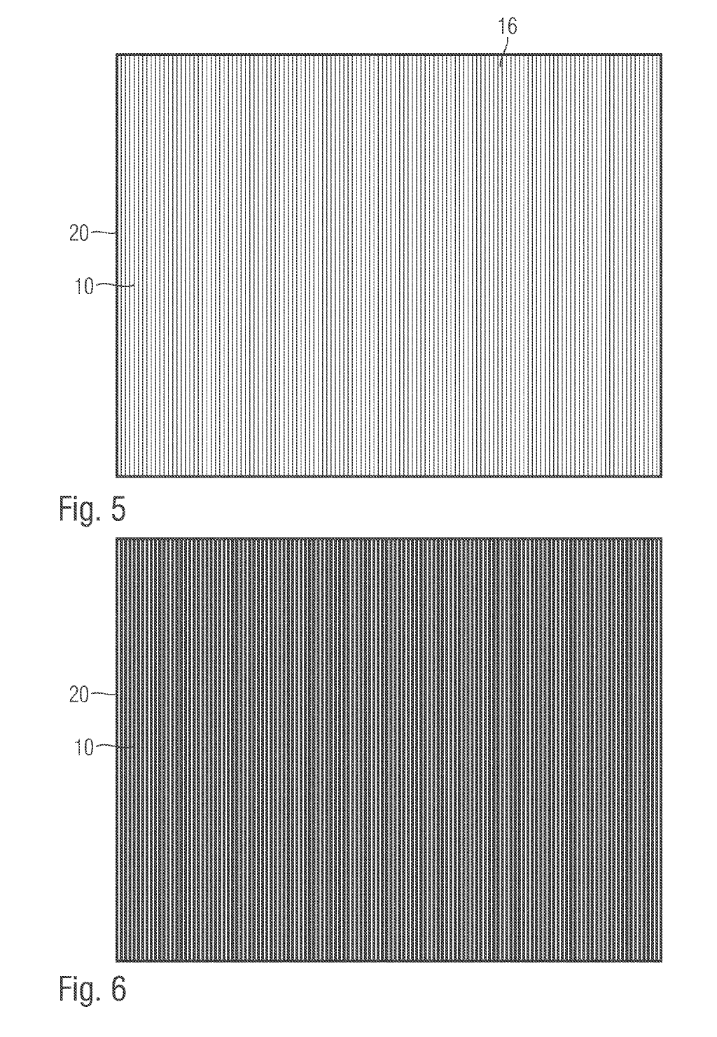

A second embodiment of the invention is explained by means of FIG. 2. The sun protection elements 10 are arranged between two panes 15 in this case as well. However, the sun protection elements 10 are not arranged parallel to one another but at different angles of inclination. Furthermore, the sun protection device 1 according to FIG. 2 contains the adaptive sun protection elements 10 which are explained by means of FIG. 4 and also conventional sun protection elements 11 having constant cross-section. According to FIG. 2, the window opening is divided into different sections which are marked by A and B in FIG. 2. Adaptive sun protection elements 10 are inserted in sections B and shadow a relatively large or small portion of the panes 15 depending on the thermal influence. In sections A, however, conventional sun protection elements 11 are inserted and shadow a constant portion of the window area.

The functioning principle of a sun protection element 10 is explained in more detail by means of FIG. 3. The sun protection element 10 shows a base body 105, e.g. made of metal or an alloy. The base body 105 has good thermal conductivity and can be made of aluminum or an aluminum alloy or a copper alloy, for example. The front face 102 of the base body 105 is carried out as a solar absorber. For example, the front face 102 can be blackened. Alternatively, the front face 102 can have a selectively absorbing coating which preferably absorbs a settable band of the sunlight.

Membranes 101 are arranged on both sides of the base body 105. In other embodiments of the invention, only one membrane 101 can be present which is attached to one side of the base body 105. The membrane 101 is attached via its longitudinal edge to the front face 103 of the base body 105. Thus, solar radiation that has an impact heats the base body 105 which gives off the heat to the membrane 101 by means of convection, thermal radiation and heat conduction. The membrane 101 deforms with increasing temperature and thus increasingly fills the intermediate space 16 between two adjacent sun protection elements 10. For the purpose of the present description, this is referred to as the closed position of the sun protection device.

It is, of course, also possible to realize a variant of the invention, in which the front face 103 of the base body 105 is used as a solar absorber.

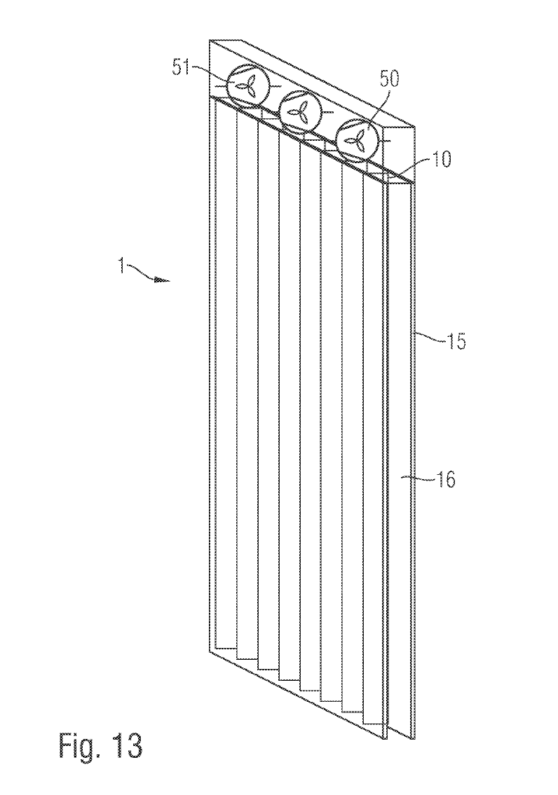

FIG. 13 shows a variant of the embodiment shown in FIGS. 1 to 3. The intermediate space 16 between the panes 15 can be ventilated by providing the bottom and top of the window frame and/or the retaining device of the panes 15 with openings. The air in the intermediate space 16 heats up during solar radiation and rises. During the energy input, the air mass is exchanged by convection, wherein the flowing air impinges on at least one fan wheel 51 of at least one fan 50. The fan wheel 51 can be rotated by means of an electric motor (not shown) or the rotor of the electric motor rotates when the fan wheel is driven.

During the energy input, it is possible to convert the kinetic energy of the flowing air into electric energy by means of the fan 50 operated as a generator. The electric energy can be stored in accumulators. In the case of a very high solar radiation which might overheat the system, the energy previously stored in the accumulators can be used for cooling. This can be achieved by either increased ventilation by means of the ventilators 50 and/or the exploitation of the thermoelectric effect and/or the use of compression refrigerating machines.

The function of a sun protection element 10 is explained again by means of FIG. 4. As already described above, the sun protection element 10 has a base body 105, the front face 102 of which is adapted to absorb solar radiation. The membranes 101 arranged on both sides are approximately flat at temperatures below about 20° C. or below about 15° C. and therefore are in the position shown in black in FIG. 4. The membranes 101 are then approximately parallel to the base body 105. The sun protection element thus has a width b. This is referred to as the open position.

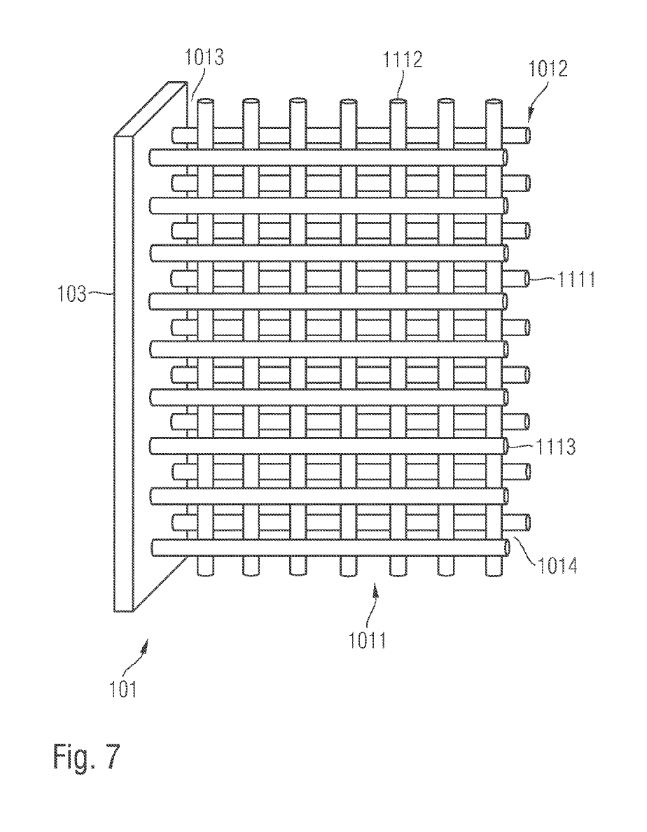

The dashed line shows the position of a membrane 101 with increasing heating. The design of the membrane 101 is explained in more detail by means of FIGS. 7 to 9. However, the fundamental principle of this embodiment of the invention is that the membrane deforms with increasing heating so as to have a concave inner surface 1011 and a convex outer surface 1012. On account of the attachment point 1013, this leads to a larger projected width B of the sun protection element 10. Due to this, the sun protection element 10 can cover a larger part of the window opening, and therefore shadowing is effected as desired. Of course, FIG. 4 can only be comprehended by way of diagram. In practice, the membranes arranged on both sides of the base body 105 will move symmetrically to each other and away from the base body 105.

An optional photovoltaic cell 40 can be arranged on the outer side 1012.

FIGS. 5 and 6 show the effect of the proposed sun protection device by means of a window opening 20. The window opening 20 is provided with a plurality of sun protection elements 10 which are shown in an open position in FIG. 5. In the open position of the sun protection elements 10, the latter have a comparatively small width b, and therefore what is left between the sun protection elements 10 is a free window area 25 through which the user in the room can view the outer surroundings.

FIG. 6 shows the condition of the sun protection device with higher heating. In this case, the width B of the sun protection elements 10 is increased, as described above by means of FIG. 4. As a result, the intermediate spaces 16 between two adjacent sun protection elements become smaller so as to limit the view out of the window 20. However, this simultaneously reduces the energy input from the solar radiation into the room behind the window opening 20.

FIGS. 7, 8 and 9 explain the design of a membrane 101 by way of example. The membranes 101 shown in the figures have the design of a three-layered biaxial stitch-bonded fabric. As evident from FIG. 7, the longitudinal edge 1013 of the membrane borders on the front face 103 of the base body 105. This is where the first layer of material 1111 and the third layer of material 1113 are attached in such a way that the respective longitudinal edges 1013 of the first layer of material 1111 and the third layer of material 1113 are not slidable against each other. The first and third layers of material are likewise attached to each other on the opposite longitudinal edge 1114 in such a way that the ends of the filaments, fibers or foil strips are not slidable against each other. In some embodiments of the invention, this can be achieved by adhesion or welding.

A second layer of material 1112 is arranged between the first layer of material 1111 and the third layer of material 1113. The second layer of material 1112 can contain or consist of carbon fibers, and therefore the membrane 101 is weather-resistant, on the one hand, and can absorb great tensile forces when having a small thickness, on the other hand. In order to enable the bulge of the membrane 101, which is shown in FIG. 4, the carbon fibers in the second layer 1112 can be arranged along the longitudinal extension of the membrane 101. The filaments, fibers or foil strips are woven with one another and with the second layer 1112, on the one hand, and the first layer 1111 and/or the third layer of material 1113, on the other hand, within the membrane plane in such a way that the distances can increase or decrease due to the thermal expansion. A different thermal expansion of the first layer of material 1111 and the third layer of material 1113 thus yields the bulge shown in FIG. 4. In order to avoid excess heating of the membrane 101, at least the outwardly facing side 1012 can be reflective. In order to avoid external dazzling, a diffusely reflecting coating can be chosen at least for the second side 1012. Due to the distance of the carbon fibers in the second layer 1112, the transmission properties of the membrane 101 can be varied.

The first layer of material 1111 can have a coefficient of thermal expansion between 5×10⁻⁵ and 2×10⁻⁴ K⁻¹. In contrast, the third layer of material 1113 can have a coefficient of thermal expansion between about 5×10⁻⁷ K⁻¹ and about 5×10⁻⁶ K⁻¹.

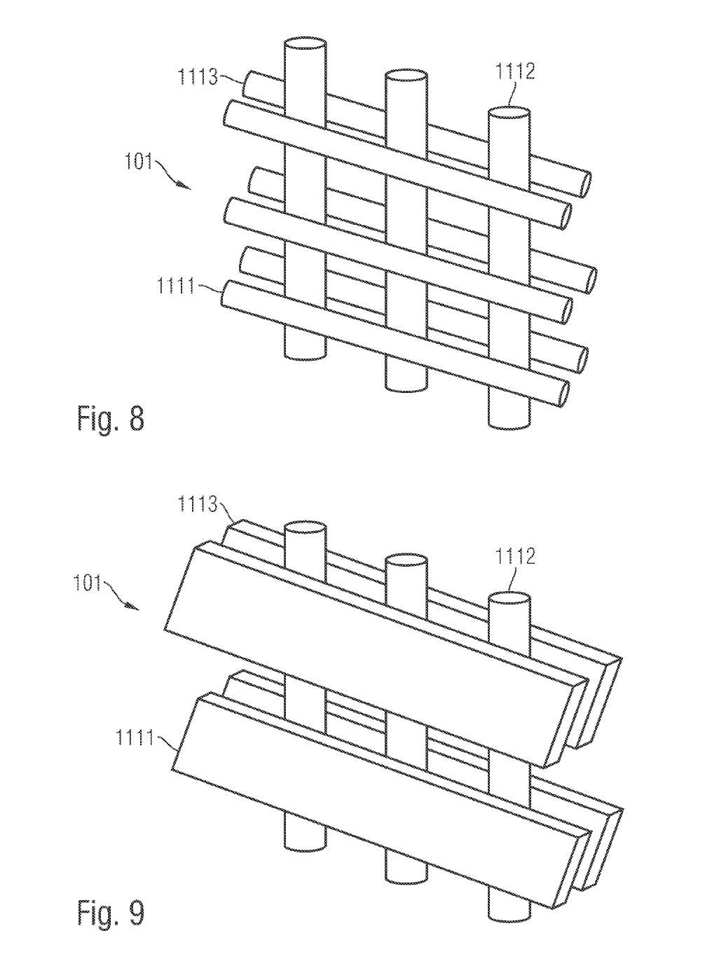

In the same way as shown for a biaxial stitch-bonded fabric by means of FIGS. 7 and 8, the membrane 101 can also contain in each case at least one foil layer in the first layer of material 1111 and the third layer of material 1113, as shown in FIG. 9. Such foil layers can be made from a plastic material or a thin rolled-out metal or an alloy, for example.

FIG. 10 shows a computer simulation of the sun protection device according to the invention. What is shown is a sun protection device 1 having a plurality of sun protection elements 10. Six sun protection elements 10 are arranged approximately in parallel in the exemplary embodiment. Each sun protection element 10 contains two membranes 101 which are arranged on both sides of a base body 105. The coefficient of thermal expansion of the first layer of material of the membrane is 1.2·10⁻⁴ K⁻¹. The coefficient of thermal expansion of the third layer of material of the membrane is 1·10⁻⁵ K⁻¹. The difference of the coefficients of thermal expansion is thus 1.1·10⁻⁴ K⁻¹. The membranes have a thickness of 60 μm, wherein the distance between the first layer of material and the third layer of material is 20 μm.

Each sun protection element 10 has a depth of 10 mm and a width b of 2 mm. Two adjacent sun protection elements 10 are arranged at a distance of 17 mm to one another.

Lines A to L according to FIG. 10 illustrate the sun protection device at respectively different temperatures. As evident from FIG. 10, an increasing temperature results in an increasing bulge of the membranes, and therefore the intermediate space 16 between two adjacent sun protection elements 10 is increasingly shadowed by the membranes 101. The shadowing and the respective temperature for the 12 presentations are shown in the below table.

| FIG. | Shadowing | temperature |
|---|---|---|
| A | 10% | <15° C. |
| B | 17% | 20° C. |
| C | 33% | 25° C. |
| D | 47% | 30° C. |
| E | 60% | 35° C. |
| F | 70% | 40° C. |
| G | 78% | 45° C. |
| H | 84% | 50° C. |
| I | 86% | 55° C. |
| J | 86% | 60° C. |
| K | 84% | 65° C. |
| L | 79% | 70° C. |

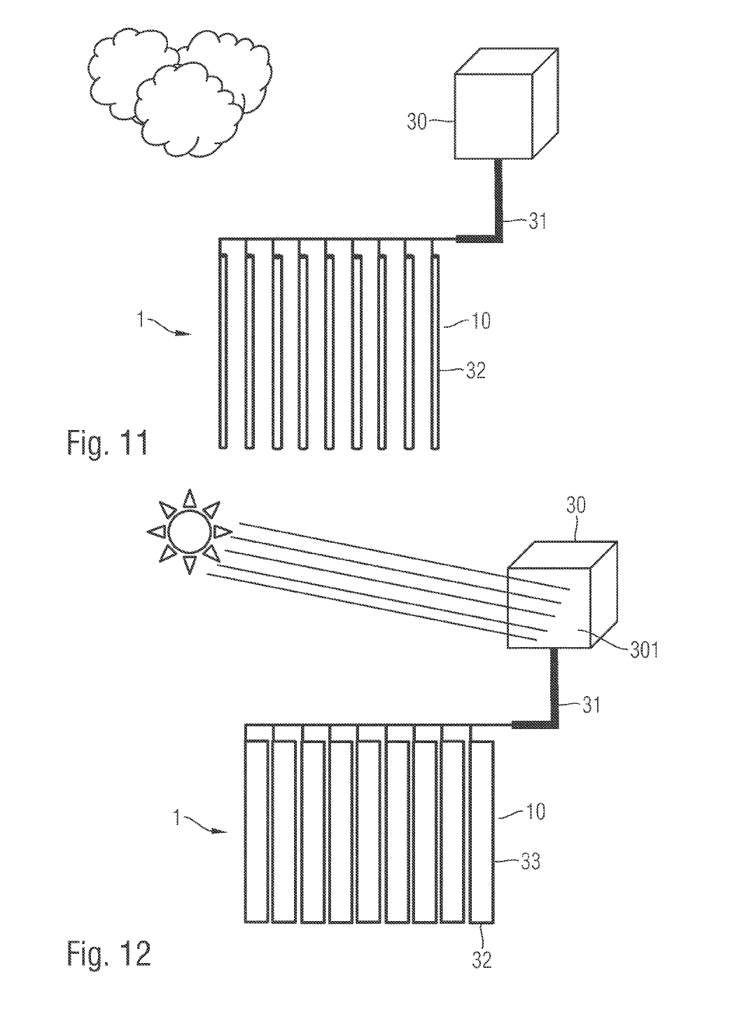

A third embodiment of the invention is explained in more detail by means of FIG. 11. FIG. 11 shows a sun protection device 1 having a plurality of sun protection elements 10. Each sun protection element 10 has a housing 32, in which a flexible membrane 33 is arranged. Each sun protection element 10 is connected to a reservoir 30 via a hydraulic line 31, said reservoir containing a hydraulic fluid. The reservoir 30 is provided with a solar absorber 301. As shown in FIG. 12, the solar absorber 301 absorbs thermal energy when the weather is favorable, thus heating the hydraulic fluid in the reservoir 30. This leads to a thermal expansion, and therefore a pressure is built up in the hydraulic line 31. This pressure leads to an extension of the membrane 33 from the housing 32. As a result, the window opening provided with the sun protection device 1 is increasingly shadowed.

In order to manually influence the sun protection elements 10, the hydraulic fluid can be heated with an additional heater, e.g. an electric heating resistor. In other embodiments of the invention, a manual or electric pump can be provided additionally or alternatively to pressurize the hydraulic fluid and close the sun protection elements 10 even in cool weather. In order to open the sun protection elements 10 by the user even in the case of high solar radiation or to prevent the closing thereof, a bypass valve can be provided in some embodiments, said valve serving for discharging the pressure in the hydraulic line 31 into the reservoir 30.

Of course, the invention is therefore not limited to the embodiments shown in the figures. The above description should thus not be considered limiting but explanatory. The below claims should be comprehended such that a feature mentioned is present in at least one embodiment of the invention. This does not rule out the presence of further features. If the claims and the above description define “first” and “second” features, this designation serves for distinguishing two like features without establishing an order.

1-17. (canceled)

18. Sun protection device having a plurality of sun protection elements, said sun protection elements each having a housing in which a flexible membrane is arranged,
wherein each sun protection element is connected to a reservoir containing a hydraulic fluid by means of a hydraulic line,
said reservoir comprising a solar absorber,
wherein the membrane is adapted to extend from the housing if the pressure in the hydraulic line increases.

19. Sun protection device according to claim 18, wherein the solar absorber is adapted to absorb thermal energy from the sun light, so as to heat the hydraulic fluid in the reservoir, thereby increasing the pressure in the hydraulic line by thermal expansion of said hydraulic fluid.

20. Sun protection device according to claim 18, comprising further a heating apparatus being adapted to heat the hydraulic fluid in the reservoir.

21. Sun protection device according to claim 19, comprising further a heating apparatus being adapted to heat the hydraulic fluid in the reservoir.

22. Sun protection device according to claim 18, comprising further a mechanical or electrical pump being adapted to increase the pressure in the hydraulic line.

23. Sun protection device according to claim 20, wherein said heating apparatus comprises a heater resistor.

24. Sun protection device according to claim 18, comprising further a bypass valve being adapted to decrease the pressure in the hydraulic line by releasing hydraulic fluid from the hydraulic line into said reservoir.

25. Sun protection device according to claim 18, wherein the hydraulic fluid comprises an alcohol or an oil.

26. Sun protection device according to claim 18, wherein each housing of said sun protection elements comprises a roller in the interior being adapted to wind up the membrane.

27. Sun protection device according to claim 18, wherein the membrane is made from a flexible plastic material

28. Sun protection device according to claim 27, wherein said flexible plastic material is made from a carbon fiber reinforced laminate or fluorinated polymer.

29. Sun protection device according to claim 18, wherein said hydraulic fluid provided by said hydraulic line acts on a transmission and/or a swiveling lever and/or piston/cylinder pairing.

30. Sun protection device having a plurality of sun protection elements, said sun protection elements each having a material strip made of a solid material,
wherein each sun protection element is connected to a reservoir containing a hydraulic fluid by means of a hydraulic line,
said reservoir comprising a solar absorber,
wherein each sun protection element can be rotated about its longitudinal axis to move it from an open position to a closed position if the pressure in the hydraulic line increases and
wherein each sun protection element can be rotated about its longitudinal axis to move it from a closed position to an open position if the pressure in the hydraulic line decreases.

31. Sun protection device according to claim 30, wherein said material strip made of a solid material comprises any of a metal, an alloy or a plastic material.

32. Sun protection device according to claim 30, wherein said hydraulic fluid provided by said hydraulic line acts on a transmission and/or a swiveling lever and/or piston/cylinder pairing.

33. Sun protection device according to claim 30, wherein the hydraulic fluid comprises any of an alcohol or an oil.

34. Sun protection device according to claim 30, wherein the solar absorber is adapted to absorb thermal energy from the sun light, so as to heat the hydraulic fluid in the reservoir, thereby increasing the pressure in the hydraulic line by thermal expansion of said hydraulic fluid.

35. Sun protection device according to claim 30, comprising further a heating apparatus being adapted to heat the hydraulic fluid in the reservoir.

36. Sun protection device according to claim 30, comprising further a mechanical or electrical pump being adapted to increase the pressure in the hydraulic line.

37. Sun protection device according to claim 35, wherein said heating apparatus comprises a heater resistor.

38. Sun protection device according to claim 30, comprising further a bypass valve being adapted to decrease the pressure in the hydraulic line by releasing hydraulic fluid from the hydraulic line into said reservoir.
